(19) United States
(12) Patent Application Publication
(10) Pub. No.: US 2012/0241193 A1
(43) Pub. Date: Sep. 27, 2012

(54) ELECTRICITY TRANSMISSION BODY AND PRODUCTION METHOD OF SAME

(75) Inventor: Tatsunori SHINODA, Sakura-shi (JP)

(73) Assignee: FUJIKURA LTD., Tokyo (JP)

(21) Appl. No.: 13/492,314

(22) Filed: Jun. 8, 2012

Related U.S. Application Data
(63) Continuation-in-part of application No. PCT/JP2010/072079, filed on Dec. 9, 2010.

(30) Foreign Application Priority Data
Dec. 11, 2009 (JP) 2009-281374
Jul. 6, 2010 (JP) 2010-153639

(51) Int. Cl. H01B 5/00; B21C 1/00

(52) U.S. Cl. 174/126.2; 72/274

(57) ABSTRACT

The present invention provides an electricity transmission body that is capable of realizing both tensile strength and elongation while having high electrical conductivity and that is also capable of adequately preventing poor conductivity attributable to the occurrence of cracking, and a production method thereof. The present invention is an electricity transmission body provided with an Al alloy conductive wire containing an Al alloy that contains 1.2 to 2.2% by mass of Fe, 0.15 to 0.4% by mass of Si, and 0.06 to 0.2% by mass of Cu, with the remainder being formed of Al and unavoidable impurities, and the mass ratio of Ti/Fe being 0.00045 to 0.00750.

### CROSS REFERENCE TO RELATED APPLICATIONS

This application is a Continuation of National Stage of International Application No. PCT/JP2010/072079 filed Dec. 9, 2010, claiming priority based on Japanese Patent Applications No. 2009-281374 filed Dec. 11, 2009 and No. 2010-153639 filed Jul. 6, 2010, the contents of all of which are incorporated herein by reference in their entirety.

### TECHNICAL FIELD

The present invention relates to an electricity transmission body such as a wire harness or battery cable and a production method thereof.

### BACKGROUND ART

The use of Al alloy conductive wire instead of soft copper wire has recently been proposed for use in electrically transmission bodies such as wire harnesses or battery cables for the purpose of reducing weight of the conductive wire and lowering costs. Aluminum alloy element wire in which prescribed incorporated amounts of Fe, Mg and Si are incorporated and the remainder consists of Al and unavoidable impurities (see Patent Documents 1 and 2), as well as aluminum alloy element wire in which prescribed incorporated amounts of Fe, Si and Mn are incorporated and the remainder consists of Al and unavoidable impurities (see Patent Document 3) have been proposed as such Al alloy conductive wire.

### PRIOR ART DOCUMENTS

### Patent Documents

Patent Document 1: Japanese Patent Application Laid-open No. 2006-19163
Patent Document 2: Japanese Patent Application Laid-open No. 2006-19164
Patent Document 3: Japanese Patent Application Laid-open No. 2006-19165

### SUMMARY OF THE INVENTION

### Problems to be Solved by the Invention

However, it was difficult for the Al alloy element wires described in the above-mentioned Patent Documents 1 to 3 to balance tensile strength and elongation while having high electrical conductivity.

In addition, in the case of producing an electricity transmission wire using an Al alloy, the Al alloy is normally melted followed by casting and drawing into a continuous cast bar. At this time, however, there were cases in which cracks occurred in the cast bar. Consequently, there were cases in which the cracks continued to expand when subsequently transported to a rolling device for hot rolling working resulting in breakage. Alternatively, even if cracks do not occur in the cast bar, after having fabricated a wire rod by rolling the cast bar, there were cases in which cracking or breakage occurred in the wire rod when drawing the wire rod. Alternatively, even if cracking and breakage did not occur in the cast bar or wire rod during the process of production, there were cases in which cracking or breakage occurred in the Al alloy conductive wire during the time that electricity transmission body was used. As a result, there were cases in which poor conductivity occurred in the electricity transmission body.

Therefore, an object of the present invention is to provide an electricity transmission body that is capable of balancing tensile strength and elongation while having high electrical conductivity and that is also capable of adequately preventing poor conductivity attributable to the occurrence of cracking.

### Means for Solving the Problems

In order to solve the above-mentioned problems, the present invention provides an electricity transmission body provided with an Al alloy conductive wire containing an Al alloy that contains 1.2 to 2.2% by mass of Fe, 0.15 to 0.4% by mass of Si, and 0.06 to 0.2% by mass of Cu, with the remainder being formed of Al and unavoidable impurities, and the mass ratio of Ti/Fe being 0.00045 to 0.00750.

According to this electricity transmission body, it is possible to balance tensile strength and elongation while having high electrical conductivity and to adequately prevent poor conductivity attributable to the occurrence of cracking.

In the above-mentioned Al alloy, the mass ratio of Ti/Fe is preferably 0.00045 to 0.00300 and more preferably 0.00045 to 0.00190.

Moreover, the present invention is a method of producing an electricity transmission body, including a conductive wire formation step of forming an Al alloy conductive wire, wherein the conductive wire formation step is a step of forming the Al alloy conductive wire by executing: a cast bar fabrication step of fabricating a cast bar by melting and casting an Al alloy; a wire rod fabrication step of fabricating a wire rod by hot working the cast bar; and a drawing step of obtaining a drawn wire body by drawing the wire rod, and in the cast bar fabrication step, as the Al alloy, an Al alloy is used that contains 1.2 to 2.2% by mass of Fe, 0.15 to 0.4% by mass of Si, and 0.06 to 0.2% by mass of Cu, with the remainder being formed of Al and unavoidable impurities, and the mass ratio of Ti/Fe being 0.00045 to 0.00750.

According to this method of producing an electricity transmission body, it is possible to produce an electricity transmission body that is capable balancing tensile strength and elongation while having high electrical conductivity and that is capable of adequately preventing poor conductivity attributable to the occurrence of cracking.

In the above-mentioned method of producing of an Al alloy conductive wire, the conductive wire formation step preferably further includes a conditioning treatment step, which is carried out after the drawing step, for carrying out any of the conditioning treatment of (a) to (d) below on the drawn wire body:

(a) conditioning treatment in which cold working is carried out after solution treatment, and then artificial aging and curing treatment is further carried out;

(b) conditioning treatment in which solution treatment is carried out followed by further carrying out artificial aging and curing treatment without carrying out cold working;

(c) conditioning treatment in which cooling is carried out after high-temperature processing followed by cold working, and then artificial aging and curing treatment is further carried out; and

(d) conditioning treatment in which high-temperature processing is carried out followed by cooling and further carrying out artificial aging and curing treatment without carrying out cold working.

In this case, tensile strength and elongation can be enhanced while also making it possible to further enhance electrical conductivity.

In the above-mentioned conditioning treatment step, the artificial aging and curing treatment is preferably carried out at 200 to 400° C.

In this case, in comparison with the case of carrying out artificial aging and curing treatment at a temperature below 200° C., added elements can be adequately precipitated and elongation can be further improved. In addition, in comparison with the case of carrying out artificial aging and curing treatment at a temperature above 400° C., precipitation of coarse particles can be adequately inhibited and decreases in tensile strength can be adequately inhibited.

Furthermore, in the present invention, an electricity transmission body refers to an article that transmits electrical power. Thus, the electricity transmission body includes a naked Al alloy conductive wire, a stranded wire conductor obtained by twisting together a plurality of Al alloy conductive wires, a covered wire obtained by covering an Al alloy conductive wire with a insulating coating layer, a cable obtained by covering one or more covered wires with a protective layer, and a wire harness composed by bundling a plurality of covered wires or cables.

### Effects of the Invention

According to the present invention, an electricity transmission body, which is capable of balancing tensile strength and elongation while having high electrical conductivity and which is also capable of adequately preventing poor conductivity attributable to the occurrence of cracking, and a production method thereof, are provided.

### BRIEF DESCRIPTION OF THE DRAWINGS

FIG. 1 is a cross-sectional view showing an embodiment of an electricity transmission body according to the present invention; and

FIG. 2 is a drawing schematically showing an example of a device for producing the Al alloy conductive wire of FIG. 1.

### MODE FOR CARRYING OUT THE INVENTION

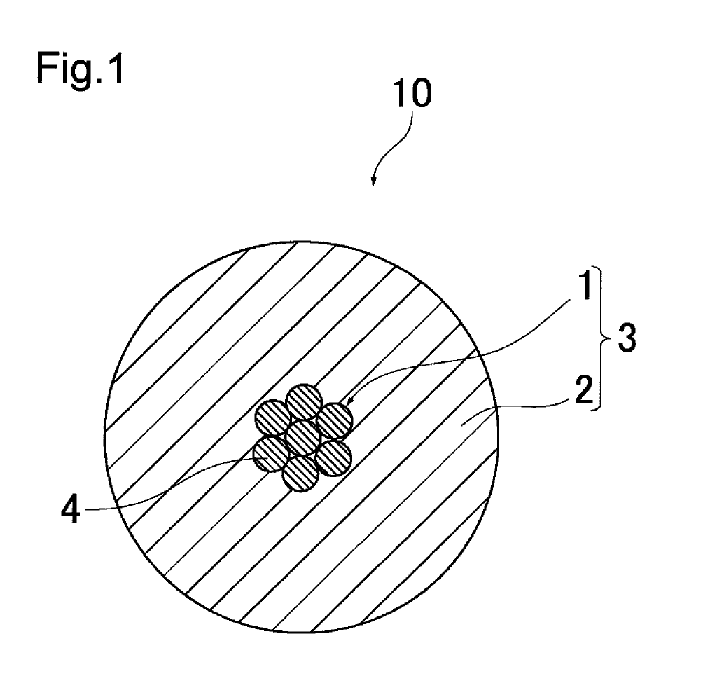

The following provides an explanation of embodiments of the electricity transmission body according to the present invention with reference to FIG. 1. FIG. 1 is a cross-sectional view showing an embodiment of the electrically transmission body of the present invention. As shown in FIG. 1, an electricity transmission body 10 is provided with a stranded wire conductor 1 and an insulating coating layer 2. Namely, the electricity transmission body 10 is composed of a covered wire 3. The stranded wire conductor 1 is formed by twisting together a plurality of Al alloy conductive wires 4.

(Al Alloy Conductive Wire)

The Al alloy conductive wire 4 contains an Al alloy. The Al alloy contains 1.2 to 2.2% by mass of Fe (iron), 0.15 to 0.4% by mass of Si (silicon) and 0.06 to 0.2% by mass of Cu (copper), the remainder consists of Al (aluminum) and unavoidable impurities, and the mass ratio of Ti/Fe is 0.00045 to 0.00750. Here, the contents of Fe, Si and Cu are on the basis (100% by mass) of the weight of the Al alloy.

The Al alloy contains 1.2 to 2.2% by mass of Fe. If the content of Fe is less than 1.2% by mass, elongation decreases thereby preventing tensile strength and elongation from being balanced. On the other hand, if the content of Fe exceeds 2.2% by mass, electrical conductivity decreases.

The Al alloy contains 0.15 to 0.4% by mass of Si. If the content of Si is less than 0.15% by mass, tensile strength decreases thereby preventing tensile strength and elongation from being balanced. On the other hand, if the content of Si exceeds 0.4% by mass, it is not possible to obtain high electrical conductivity. In addition, it is also not possible to balance tensile strength and elongation since elongation decreases.

The Al alloy contains 0.06 to 0.2% by mass of Cu. If the content of Cu is less than 0.06% by mass, tensile strength decreases thereby preventing tensile strength and elongation from being balanced. On the other hand, if the content of Cu exceeds 0.2% by mass, it is not possible to obtain high electrical conductivity. In addition, it is also not possible to balance tensile strength and elongation since elongation decreases.

Moreover, the mass ratio of Ti/Fe in the Al alloy is 0.00045 to 0.00750. If the ratio of Ti/Fe is less than 0.00045, cracks form in a cast bar when fabricating the cast bar by casting or cracks occur when drawing a wire rod obtained by hot working the cast bar. Alternatively, cracking or breakage occur in the Al alloy conductive wire 4 during the use of the electricity transmission body 10 causing the electricity transmission body 10 to have poor conductivity. In addition, if the ratio of Ti/Fe exceeds 0.00750, it is not possible to balance tensile strength and elongationin the Al alloy conductive wire 4 in the case the Fe content is low. In addition, the electrical conductivity of the Al alloy conductive wire 4 becomes low if the Ti content is high.

Furthermore, the remainder contains Al and unavoidable impurities. It is desirable that the Al has high purity in order to obtain favorable electrical conductivity of the Al alloy conductive wire 4. More specifically, the purity of the Al is preferably 99.95% or more. Since unavoidable impurities cause a decrease in electrical conductivity, the content thereof is preferably as low as possible.

In the Al alloy, the mass ratio of Ti/Fe is preferably 0.00045 to 0.00600, more preferably 0.00045 to 0.00500, even more preferably 0.00045 to 0.00300, and most preferably 0.00045 to 0.00190. In this case, tensile strength can be further improved in comparison with the case of the ratio of Ti/Fe deviating from the range of 0.00045 to 0.00600.

(Insulating Coating Layer)

The insulating coating layer 2 is composed of an insulating material. A synthetic resin and the like are normally used for the insulating material.

Next, an explanation is provided of a method of producing the electricity transmission body 10.

[Conductive Wire Formation Step]

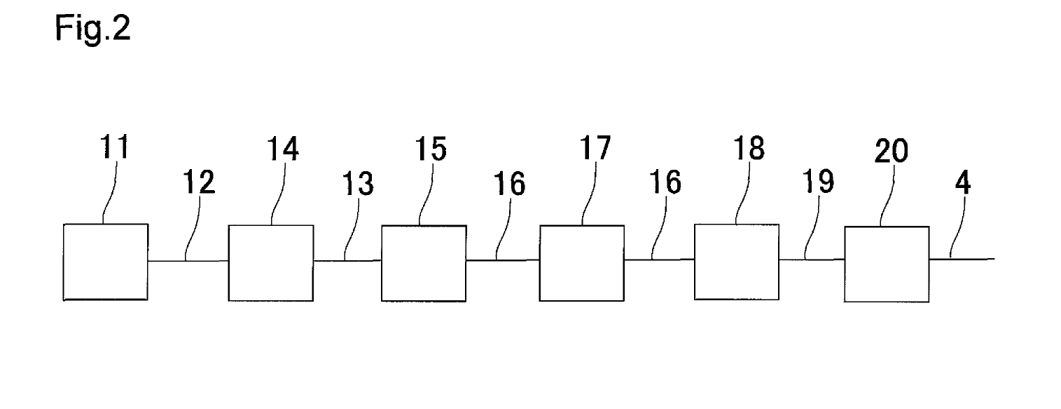

First, the Al alloy conductive wire 4 is formed. The following provides an explanation of a method of producing the Al alloy conductive wire 4 with reference to FIG. 2. FIG. 2 is a drawing schematically showing an example of a device for producing the Al alloy conductive wire of FIG. 1.

(Cast Bar Fabrication Step)

To begin with, Fe, Si, Cu, Ti and Al having contents within the previously described ranges are melted and cast with a continuous casting machine 11 to fabricate a cast bar 12 as shown in FIG. 2.

(Wire Rod Fabrication Step)

A wire rod 13 is then fabricated by hot rolling the cast bar 12. Normally, a hot rolling machine 14 is connected in tandem to the continuous casting machine 11. Although there are no particular limitations on the diameter of the wire rod 13, the diameter can be, for example, about 9.0 to 10.0 mm.

(Drawing Step)

Next, the wire rod 13 is cold-drawn with a wire drawing machine 15 to draw to a diameter of, for example, about 5.0 to 6.0 mm and obtain a drawn wire body 16.

(Conditioning Treatment Step)

Next, solution treatment is carried out on the drawn wire body 16 with a solution treatment device 17. This solution treatment is carried out to obtain a uniform solid solution of the added elements. Solution treatment is preferably carried out at 500 to 580° C. If solution treatment is carried out within this temperature range, the added elements can be made to be more uniform than in the case of carrying out solution treatment at a temperature lower than 500° C. In addition, partial melting of the drawn wire body 16 is adequately inhibited in comparison with the case of carrying out solution treatment at a temperature higher than 580° C. Furthermore, the preferable treatment time varies according to the temperature of solution treatment. In the case of carrying out solution treatment at 550° C., treatment time is preferably 2.5 to 3.5 hours and more preferably 3 hours. Following this solution treatment, the drawn wire body 16 may or may not be cooled by water cooling or the like.

Next, cold drawing is carried out on the drawn wire body 16 with a wire drawing machine 18 to fabricate an Al alloy element wire 19 with the intended diameter. The diameter of the Al alloy element wire 19 is only required to be smaller than the diameter of the drawn wire body 16, and is normally about 0.3 to 0.4 mm.

Artificial aging and curing treatment is then carried out on the Al alloy element wire 19 with an artificial aging and curing treatment device 20. Artificial aging and curing treatment is a treatment in which an excess of added elements in solid solution are finely precipitated. This artificial aging and curing treatment is preferably carried out at 200 to 400° C. and more preferably carried out at 200 to 300° C. In this case, the added elements can be adequately precipitated and elongation can be further improved in comparison with the case of carrying out artificial aging and curing treatment at a temperature below 200° C. In addition, precipitation of coarse particles can be adequately inhibited and decreases in tensile strength can be adequately inhibited in comparison with the case of carrying out artificial aging and curing treatment above 400° C. The preferable time of artificial aging and curing treatment varies according to the treatment temperature, composition and the like. For example, as the treatment temperature becomes higher, typically the artificial aging and curing treatment time becomes shorter, while as the treatment temperature becomes lower, the artificial aging and curing treatment time becomes longer. Normally, the treatment time is about 10 minutes to 5 hours. For example, in the case the treatment temperature is 200° C., the treatment time is 3 hours, in the case the treatment temperature is 250° C., the treatment time is 0.5 hours, and in the case the treatment temperature is 300° C., the treatment time is 0.17 hours.

The Al alloy conductive wire 4 is obtained in this manner. The stranded wire conductor 1 is then obtained by preparing a plurality of these Al alloy conductive wires 4 and twisting them together.

[Insulating Coating Layer Formation Step]

Next, the stranded wire conductor 1 is covered with the insulating coating layer 2. In order to cover the stranded wire conductor 1 with the insulating coating layer 2, the Al alloy conductive wire 4 is introduced into a crosshead and the like of an extruding machine and covered with a synthetic resin extruded from the extruding machine in the form of a tube.

The electricity transmission body 10 composed of the covered wire 3 is obtained in this manner.

The present invention is not limited to the above-mentioned embodiment. For example, although the electricity transmission body 10 in the above-mentioned embodiment is provided with the stranded wire conductor 1 obtained by twisting together a plurality of the Al alloy conductive wires 4, instead of the stranded wire conductor 1, a stranded wire conductor may be provided that is obtained by further twisting together a plurality of the stranded wire conductors 1, and a compressed conductor which is obtained by compressing these stranded wire conductors 1 so that the cross-sections of these stranded wire conductors 1 have a circular shape.

In addition, although the electricity transmission body 10 in the above-mentioned embodiment is composed with a single covered wire 3, the electricity transmission body 10 may also be a wire harness composed by bundling a plurality of the covered wires 3, or may be a cable (such as a battery cable) obtained by covering one or more covered wires with a protective layer.

Moreover, although the electricity transmission body 10 in the above-mentioned embodiment is provided with the insulating coating layer 2, the insulating coating layer 2 can also be omitted. Namely, the electricity transmission body 10 may be composed of a naked stranded wire conductor 1, or may be composed only of a single Al alloy conductive wire 4.

In addition, although hot working of the cast bar 12, for example, is carried out by hot rolling working in the manner previously described in the above-mentioned embodiment, it may also be carried out by hot extrusion working. In addition, drawing of the wire rod 13 may be carried out by another known method instead of cold working.

Moreover, although solution treatment is carried out on the drawn wire body 16 obtained by drawing the wire rod 13, cold working is carried out following solution treatment, and further conditioning treatment in accordance with JIS T8 stipulating artificial aging and curing treatment is carried out in the above-mentioned embodiment for the purpose of enhancing tensile strength and elongation as well as further enhancing electrical conductivity, other conditioning treatment may be carried out instead of that in accordance with JIS T8. Namely, conditioning treatment may be carried out by a method in which in which solution treatment is carried out on the drawn wire body 16 followed by further carrying out artificial aging and curing treatment without carrying out cold working (JIS T6), a method in which high-temperature processing is carried out on the drawn wire body 16 followed by cooling and cold working, followed by further carrying out artificial aging and curing treatment (JIS T10), or a method in which high-temperature processing is carried out on the drawn wire body 16 followed by cooling and further carrying out artificial aging and curing treatment without carrying out cold working (JIS T5). Here, high-temperature processing refers to treating the drawn wire body 16 at a high temperature of 400 to 550° C. Furthermore, the above-mentioned condition treatment can also be omitted. In this case, the drawn wire body 16 in itself is used as the Al alloy conductive wire 4.

### EXAMPLES

Although the following provides a more specific explanation of the contents of the present invention by listing examples and comparative examples thereof, the present invention is not limited to the following examples.

### Examples 1 to 42 and Comparative Examples 1 to 13

Fe, Si, Cu, Ti and Al were melted in the compositions shown in Tables 1 to 3 followed by casting with a continuous casting machine to fabricate cast bars having a diameter of 25 mm. The cast bars were then hot-rolled to fabricate wire rods having a diameter of 9.8 mm. The wire rods were then cold-drawn to a diameter of 0.33 mm to obtain Al alloy element wires. The Al alloy element wires were subjected to aging and curing treatment at the aging and curing treatment temperatures and times shown in Tables 1 to 3. Al alloy conductive wires were obtained in this manner.

Tensile strength and elongation were then measured for the Al alloy conductive wires obtained in this manner by carrying out tensile tests at 20° C. in compliance with JIS C3002. The results are shown in Tables 1 to 3.

In addition, electrical conductivity of the Al alloy conductive wires was measured at 20° C. The results are shown in Tables 1 to 3.

Moreover, the cast bars and wire rods were visually observed for the occurrence of cracking. The results are shown in Tables 1 to 3.

Evaluation (Assessment) on the Al alloy conductive wires were conducted based on the following criteria:

(1) tensile strength of 140 MPa or more;

(2) elongation of 12% or more;

(3) electrical conductivity of 58% IACS or more; and

(4) absence of crack occurrence in the cast bar and wire rod.

Those Al alloy conductive wires that satisfied all of the criteria of (1) to (4) above were evaluated as being acceptable and indicated with “O” in Tables 1 to 3. On the other hand, those Al alloy conductive wires that did not satisfy any one of the criteria of (1) to (4) above were evaluated as unacceptable and indicated with “x” in Tables 1 to 3. Here, Al alloy conductive wires having tensile strength of 140 MPa or more were evaluated as acceptable because tensile strength required for realizing tensile strength equal to that of soft copper wire (about 210 MPa) with Al alloy wire having a cross-sectional area 1.5 times greater than that of soft copper wire is 210 MPa×⅔=140 MPa. Furthermore, even if the cross-sectional area of the Al alloy conductive wire is made to be 1.5 times greater than that of soft copper wire, it is possible to make the Al alloy conductive wire lighter than soft copper wire since the density of aluminum is 2.7 g/cm³ while the density of copper is 8.9 g/cm³.

TABLE 1

| | | | | | | | Aging/Curing | | | | | | |
|---|---|---|---|---|---|---|---|---|---|---|---|---|---|
| | | | | | | | Treatment | | Tensile | Elonga- | Electrical | | |
| | Elements (mass %) | | | | | | Temp. | Time | Strength | tion | conductivity | | |
| | Fe | Si | Cu | Ti | Al | Ti/Fe | (° C.) | (h) | (MPa) | (%) | (% IACS) | Cracking | Evaluation |
| Ex. 1 | 1.8 | 0.2 | 0.1 | 0.001 | Remainder | 0.00056 | 220 | 3 | 145.9 | 12.2 | 58.8 | None | ∘ |
| Ex. 2 | 1.7 | 0.2 | 0.1 | 0.001 | Remainder | 0.00059 | 260 | 3 | 144.2 | 18.0 | 58.9 | None | ∘ |
| Ex. 3 | 1.9 | 0.2 | 0.1 | 0.002 | Remainder | 0.00110 | 300 | 3 | 141.9 | 17.9 | 58.8 | None | ∘ |
| Ex. 4 | 1.7 | 0.2 | 0.1 | 0.001 | Remainder | 0.00059 | 400 | 0.083 | 141.7 | 12.0 | 58.4 | None | ∘ |
| Ex. 5 | 1.6 | 0.2 | 0.1 | 0.001 | Remainder | 0.00063 | 230 | 3 | 140.2 | 14.8 | 59.4 | None | ∘ |
| Ex. 6 | 2 | 0.2 | 0.1 | 0.001 | Remainder | 0.00050 | 230 | 3 | 142.3 | 14.6 | 58.7 | None | ∘ |
| Ex. 7 | 2.2 | 0.2 | 0.1 | 0.004 | Remainder | 0.00182 | 230 | 3 | 142.0 | 13.0 | 58.3 | None | ∘ |
| Ex. 8 | 1.2 | 0.2 | 0.1 | 0.002 | Remainder | 0.00167 | 230 | 3 | 143.0 | 13.9 | 60.9 | None | ∘ |
| Ex. 9 | 1.8 | 0.15 | 0.1 | 0.003 | Remainder | 0.00167 | 230 | 3 | 142.5 | 15.1 | 59.3 | None | ∘ |
| Ex. 10 | 1.6 | 0.4 | 0.08 | 0.003 | Remainder | 0.00188 | 230 | 3 | 140.9 | 14.2 | 58.3 | None | ∘ |
| Ex. 11 | 1.7 | 0.2 | 0.06 | 0.003 | Remainder | 0.00176 | 230 | 3 | 142.3 | 13.9 | 59.4 | None | ∘ |
| Ex. 12 | 1.7 | 0.2 | 0.2 | 0.003 | Remainder | 0.00176 | 230 | 3 | 140.9 | 14.9 | 59.5 | None | ∘ |
| Ex. 13 | 1.4 | 0.3 | 0.1 | 0.002 | Remainder | 0.00143 | 230 | 3 | 142.5 | 12.5 | 58.8 | None | ∘ |
| Ex. 14 | 1.7 | 0.2 | 0.15 | 0.003 | Remainder | 0.00176 | 230 | 3 | 142.8 | 12.8 | 59.2 | None | ∘ |
| Ex. 15 | 1.8 | 0.2 | 0.1 | 0.005 | Remainder | 0.00280 | 220 | 3 | 146.7 | 17.6 | 58.7 | None | ∘ |
| Ex. 16 | 1.8 | 0.15 | 0.1 | 0.005 | Remainder | 0.00280 | 220 | 3 | 142.3 | 14.2 | 59.2 | None | ∘ |
| Ex. 17 | 1.8 | 0.4 | 0.1 | 0.005 | Remainder | 0.00280 | 220 | 3 | 141.9 | 14.5 | 58.0 | None | ∘ |
| Ex. 18 | 1.8 | 0.2 | 0.06 | 0.005 | Remainder | 0.00280 | 220 | 3 | 143.4 | 13.8 | 59.0 | None | ∘ |
| Ex. 19 | 1.8 | 0.2 | 0.2 | 0.005 | Remainder | 0.00280 | 220 | 3 | 145.6 | 12.9 | 58.0 | None | ∘ |
| Ex. 20 | 1.8 | 0.2 | 0.1 | 0.005 | Remainder | 0.00280 | 220 | 5 | 142.1 | 18.5 | 58.8 | None | ∘ |
| Ex. 21 | 2.2 | 0.2 | 0.1 | 0.006 | Remainder | 0.00270 | 350 | 3 | 145.2 | 18.1 | 58.0 | None | ∘ |

TABLE 2

| | | | | | | | Aging/Curing | | | | | | |
|---|---|---|---|---|---|---|---|---|---|---|---|---|---|
| | | | | | | | Treatment | | Tensile | Elonga- | Electrical | | |
| | Elements (mass %) | | | | | | Temp. | Time | Strength | tion | conductivity | | |
| | Fe | Si | Cu | Ti | Al | Ti/Fe | (° C.) | (h) | (MPa) | (%) | (% IACS) | Cracking | Evaluation |
| Ex. 22 | 1.4 | 0.2 | 0.1 | 0.005 | Remainder | 0.00360 | 220 | 3 | 140.9 | 12.3 | 60.0 | None | ∘ |
| Ex. 23 | 1.8 | 0.2 | 0.1 | 0.005 | Remainder | 0.00280 | 230 | 3 | 141.5 | 15.4 | 59.0 | None | ∘ |
| Ex. 24 | 1.7 | 0.2 | 0.1 | 0.005 | Remainder | 0.00290 | 220 | 3 | 146.1 | 12.0 | 58.9 | None | ∘ |
| Ex. 25 | 1.8 | 0.2 | 0.1 | 0.009 | Remainder | 0.00500 | 220 | 3 | 142.3 | 13.8 | 58.1 | None | ∘ |
| Ex. 26 | 1.2 | 0.2 | 0.1 | 0.005 | Remainder | 0.00420 | 230 | 3 | 140.3 | 14.2 | 60.7 | None | ∘ |
| Ex. 27 | 2.2 | 0.2 | 0.1 | 0.005 | Remainder | 0.00227 | 230 | 3 | 140.9 | 13.7 | 58.2 | None | ∘ |
| Ex. 28 | 1.2 | 0.2 | 0.1 | 0.003 | Remainder | 0.00250 | 230 | 3 | 141.6 | 14.2 | 60.8 | None | ∘ |
| Ex. 29 | 1.8 | 0.15 | 0.1 | 0.005 | Remainder | 0.00278 | 230 | 3 | 141.8 | 14.8 | 59.2 | None | ∘ |
| Ex. 30 | 1.6 | 0.4 | 0.08 | 0.004 | Remainder | 0.00250 | 230 | 3 | 141.2 | 13.9 | 58.2 | None | ∘ |
| Ex. 31 | 1.7 | 0.2 | 0.06 | 0.005 | Remainder | 0.00294 | 230 | 3 | 143.3 | 14.1 | 59.2 | None | ∘ |
| Ex. 32 | 1.7 | 0.2 | 0.2 | 0.004 | Remainder | 0.00235 | 230 | 3 | 142.0 | 13.9 | 59.3 | None | ∘ |
| Ex. 33 | 1.4 | 0.3 | 0.1 | 0.004 | Remainder | 0.00286 | 230 | 3 | 142.2 | 13.1 | 58.7 | None | ∘ |
| Ex. 34 | 1.7 | 0.2 | 0.15 | 0.005 | Remainder | 0.00294 | 230 | 3 | 141.9 | 14.0 | 58.9 | None | ∘ |
| Ex. 35 | 2.2 | 0.2 | 0.1 | 0.007 | Remainder | 0.00318 | 230 | 3 | 141.5 | 13.8 | 58.0 | None | ∘ |
| Ex. 36 | 1.2 | 0.2 | 0.1 | 0.007 | Remainder | 0.00583 | 230 | 3 | 142.1 | 13.9 | 60.1 | None | ∘ |
| Ex. 37 | 1.8 | 0.15 | 0.1 | 0.009 | Remainder | 0.00500 | 230 | 3 | 142.0 | 15.3 | 58.9 | None | ∘ |
| Ex. 38 | 1.6 | 0.4 | 0.08 | 0.009 | Remainder | 0.00563 | 230 | 3 | 141.5 | 13.5 | 58.0 | None | ∘ |
| Ex. 39 | 1.7 | 0.2 | 0.06 | 0.008 | Remainder | 0.00471 | 230 | 3 | 141.5 | 14.2 | 59.0 | None | ∘ |
| Ex. 40 | 1.7 | 0.2 | 0.2 | 0.009 | Remainder | 0.00529 | 230 | 3 | 141.4 | 14.2 | 58.8 | None | ∘ |
| Ex. 41 | 1.4 | 0.3 | 0.1 | 0.008 | Remainder | 0.00571 | 230 | 3 | 143.0 | 12.7 | 58.4 | None | ∘ |
| Ex. 42 | 1.7 | 0.2 | 0.15 | 0.008 | Remainder | 0.00471 | 230 | 3 | 142.3 | 13.8 | 58.3 | None | ∘ |

TABLE 3

| | | | | | | | Aging/Curing | | | | | | |
|---|---|---|---|---|---|---|---|---|---|---|---|---|---|
| | | | | | | | Treatment | | Tensile | Elonga- | Electrical | | |
| | Elements (mass %) | | | | | | Temp. | Time | Strength | tion | conductivity | | |
| | Fe | Si | Cu | Ti | Al | Ti/Fe | (° C.) | (h) | (MPa) | (%) | (% IACS) | Cracking | Evaluation |
| Comp. | 0.5 | 0.2 | 0.1 | 0.005 | Remainder | 0.01000 | 210 | 3 | 145.2 | 9.8 | 60.9 | None | x |
| Ex. 1 | | | | | | | | | | | | | |
| Comp. | 2.5 | 0.2 | 0.1 | 0.005 | Remainder | 0.00200 | 220 | 3 | 148.5 | 12.3 | 55.8 | None | x |
| Ex. 2 | | | | | | | | | | | | | |
| Comp. | 1.8 | 0.1 | 0.1 | 0.005 | Remainder | 0.00280 | 220 | 3 | 139.2 | 14.5 | 59.7 | None | x |
| Ex. 3 | | | | | | | | | | | | | |
| Comp. | 1.8 | 0.5 | 0.1 | 0.005 | Remainder | 0.00280 | 220 | 3 | 145.8 | 10.9 | 57.2 | None | x |
| Ex. 4 | | | | | | | | | | | | | |
| Comp. | 1.8 | 0.2 | 0.05 | 0.005 | Remainder | 0.00280 | 220 | 3 | 138.7 | 14.6 | 59.2 | None | x |
| Ex. 5 | | | | | | | | | | | | | |
| Comp. | 1.8 | 0.2 | 0.3 | 0.005 | Remainder | 0.00280 | 220 | 3 | 147.9 | 9.7 | 57.4 | None | x |
| Ex. 6 | | | | | | | | | | | | | |
| Comp. | 1.8 | 0.2 | 0.1 | 0 | Remainder | 0 | 220 | 3 | 145.7 | 10.2 | 58.4 | Present | x |
| Ex. 7 | | | | | | | | | | | | | |
| Comp. | 1.8 | 0.2 | 0.1 | 0.05 | Remainder | 0.02800 | 220 | 2 | 144.3 | 13.2 | 55.9 | None | x |
| Ex. 8 | | | | | | | | | | | | | |
| Comp. | 1.8 | 0.2 | 0.1 | 0.04 | Remainder | 0.02200 | 220 | 3 | 143.9 | 13.0 | 56.2 | None | x |
| Ex. 9 | | | | | | | | | | | | | |
| Comp. | 2.4 | 0.2 | 0.1 | 0.005 | Remainder | 0.00210 | 220 | 3 | 147.6 | 15.2 | 56.2 | None | x |
| Ex. 10 | | | | | | | | | | | | | |
| Comp. | 1.6 | 0.2 | 0.1 | 0.02 | Remainder | 0.01250 | 220 | 3 | 145.5 | 12.2 | 57.8 | None | x |
| Ex. 11 | | | | | | | | | | | | | |
| Comp. | 2.2 | 0.2 | 0.1 | 0.0008 | Remainder | 0.00036 | 230 | 3 | 140.9 | 13.8 | 58.3 | Present | x |
| Ex. 12 | | | | | | | | | | | | | |
| Comp. | 2.4 | 0.2 | 0.1 | 0.001 | Remainder | 0.00042 | 230 | 3 | 142.8 | 12.8 | 58.0 | Present | x |
| Ex. 13 | | | | | | | | | | | | | |

According to the results shown in Tables 1 to 3, Examples 1 to 42 that satisfy the requirements of the present invention satisfied all of the criteria of (1) to (4) above. Thus, they were evaluated as acceptable. On the other hand, Comparative Examples 1 to 13 that do not satisfy the requirements of the present invention were unable to satisfy at least one of the criteria of (1) to (4) above. Thus, they were evaluated as unacceptable.

On the basis of the above, it was confirmed that according to the electricity transmission body of the present invention, it is possible to balance tensile strength and elongation while having high electrical conductivity, and to adequately prevent poor conductivity attributable to the occurrence of cracking.

### INDUSTRIAL APPLICABILITY

Since the electricity transmission body of the present invention is able to balance tensile strength and elongation while having high electrical conductivity and to adequately prevent poor conductivity attributable to the occurrence of cracking, it can be used as a wire harness, battery cable and the like.

### EXPLANATION OF REFERENCE NUMERALS

2 Insulating coating layer
3 Covered wire (electricity transmission body)
4 Al alloy conductive wire
10 Electricity transmission body
12 Cast bar
13 Wire rod
16 Drawn wire body

1. An electricity transmission body provided with an Al alloy conductive wire, containing: an Al alloy that contains 1.2 to 2.2% by mass of Fe, 0.15 to 0.4% by mass of Si, and 0.06 to 0.2% by mass of Cu, with the remainder being formed of Al and unavoidable impurities, and the mass ratio of Ti/Fe being 0.00045 to 0.00750.

2. The electricity transmission body according to claim 1, wherein the mass ratio of Ti/Fe in the Al alloy is 0.00045 to 0.00300.

3. The electricity transmission body according to claim 1, wherein the mass ratio of Ti/Fe in the Al alloy is 0.00045 to 0.00190.

4. A method of producing an electricity transmission body, comprising a conductive wire formation step of forming an Al alloy conductive wire, wherein
the conductive wire formation step is a step of forming the Al alloy conductive wire by executing:
a cast bar fabrication step of fabricating a cast bar by melting and casting an Al alloy;
a wire rod fabrication step of fabricating a wire rod by hot working the cast bar; and
a drawing step of obtaining a drawn wire body by drawing the wire rod, and
in the cast bar fabrication step, as the Al alloy, an Al alloy is used that contains 1.2 to 2.2% by mass of Fe, 0.15 to 0.4% by mass of Si, and 0.06 to 0.2% by mass of Cu, with the remainder being formed of Al and unavoidable impurities, and the mass ratio of Ti/Fe being 0.00045 to 0.00750.

5. The method of producing an electricity transmission body according to claim 4, wherein the conductive wire formation step further comprises a conditioning treatment step, which is carried out after the drawing step, for carrying out any of the conditioning treatment of (a) to (d) below on the drawn wire body:
(a) conditioning treatment in which cold working is carried out after solution treatment, and then artificial aging and curing treatment is further carried out;
(b) conditioning treatment in which solution treatment is carried out followed by further carrying out artificial aging and curing treatment without carrying out cold working;
(c) conditioning treatment in which cooling is carried out after high-temperature processing followed by cold working, and then artificial aging and curing treatment is further carried out; and
(d) conditioning treatment in which high-temperature processing is carried out followed by cooling and further carrying out artificial aging and curing treatment without carrying out cold working.

6. The method of producing an electricity transmission body according to claim 5, wherein the artificial aging and curing treatment in the conditioning treatment step is carried out at 200 to 400° C.
